(19) United States
(12) Patent Application Publication
(10) Pub. No.: US 2008/0196366 A1
(43) Pub. Date: Aug. 21, 2008

(54) SURFACE CLEANING APPARATUS ADAPTED FOR USE WITH LINER

(75) Inventor: Wayne Ernest Conrad, Hampton (CA)

Correspondence Address: BERESKIN AND PARR, 40 KING STREET WEST, BOX 401, TORONTO, ON, M5H 3Y2, omitted

(73) Assignee: G.B.D. CORP., Nassau (BS)

(21) Appl. No.: 11/954,333

(22) Filed: Dec. 12, 2007

Related U.S. Application Data
(60) Provisional application No. 60/894,005, filed on Mar. 9, 2007.
(60) Provisional application No. 60/869,586, filed on Dec. 12, 2006.

(51) Int. Cl. B01D 45/12

(52) U.S. Cl. 55/337

(57) ABSTRACT

A surface cleaning apparatus is disclosed. In some embodiments, the surface cleaning apparatus comprises a member having a dirty fluid inlet. A fluid flow path extends from the dirty fluid inlet to a clean air outlet of the surface cleaning apparatus, and includes a suction motor. At least a first air cleaning unit comprising a cyclonic cleaning stage is positioned in the fluid flow path. A material collection chamber is in flow communication with the at least one cyclone and is adapted to receive a liner bag. A vacuum line extends between the fluid flow path and an interior of the material collection chamber and is connectable in flow communication with the fluid flow path. A valve is associated with the vacuum line and moveable between a first position in which the vacuum line is open and a second position wherein the line is closed.

### CROSS REFERENCES TO RELATED APPLICATIONS

This application claims priority from U.S. Provisional applications 60/894,005 (filed on Mar. 9, 2007), and 60/869,586 (filed on Dec. 12, 2006), all of which are incorporated herein by reference in their entirety.

### FIELD OF THE INVENTION

The invention relates to surface cleaning apparatuses such as vacuum cleaners, wet/dry vacuum cleaner and carpet extractors. More specifically, the invention relates to surface cleaning apparatus, which comprise a chamber having a removable liner.

### BACKGROUND OF THE INVENTION

Various types of vacuum cleaners are known in the art. Traditionally, vacuum cleaners have utilized a filtration bag. Accordingly, the dirty air, which was drawn into the vacuum cleaner, was conveyed into a porous bag. As the air traveled through the bag, the entrained dirt was separated from the air stream. More recently, cyclonic vacuum cleaners have been developed. Cyclonic vacuum cleaners may be used to collect particulate matter (i.e. dirt). Cyclonic vacuum cleaners are advantageous, as they do not utilize a filter bag that must be replaced. Rather, cyclonic vacuum cleaners use a chamber, which collects dirt or fluid removed from the air stream. As the chamber fills, it must be emptied by a user. Accordingly, the chamber, or the entire vacuum cleaner, may be transported to a position above a receptacle (e.g. a garbage bin or a drain) and opened so as to allow the dirt or fluid to pour into the receptacle. In the case of particulate matter, when the particulate matter is poured into the receptacle, captured particulate matter may be released into the surrounding environment. In the case of fluid, when the fluid is poured into a drain, spills may occur.

### SUMMARY OF THE INVENTION

In accordance with this invention, a surface cleaning apparatus has a collection chamber that is capable of receiving a removable liner, such as a liner bag. A vacuum line is provided so as to create a lower pressure between the liner bag and the wall of the collection chamber, then the pressure within the liner bag, when the surface cleaning apparatus is in use. Accordingly, the liner bag will be drawn towards the wall of the collection chamber. A valve is provided which may be used to reduce or prevent flow through a vacuum line when a liner is not positioned in the collection chamber.

In one broad aspect, a surface cleaning apparatus is provided. The surface cleaning apparatus comprises a member having a dirty fluid inlet. A fluid flow path extends from the dirty fluid inlet to a clean air outlet of the surface cleaning apparatus, and includes a suction motor. At least a first air cleaning unit comprising a cyclonic cleaning stage is positioned in the fluid flow path. A material collection chamber is in flow communication with the at least one cyclone and is adapted to receive a liner bag. A vacuum line extends between the fluid flow path and an interior of the material collection chamber and is connectable in flow communication with the fluid flow path. A valve is associated with the vacuum line and moveable between a first position in which the vacuum line is open and a second position wherein the line is closed.

Embodiments in accordance with this broad aspect may be advantageous because the valve may allow the apparatus to be used with a liner bag, or without a liner bag, according to the preference of the user. Accordingly, if a user elects to use the apparatus without a liner bag, the valve may be moved to the closed position, such that material in the dirt collection chamber may not enter the vacuum line. In particular, if the vacuum line is drawn from a position downstream of the cleaning unit or units of a surface cleaning apparatus, then the withdrawn dirt may clog the suction motor. Further, the withdrawn material may become trapped in the vacuum line thereby reducing or eliminating flow therethrough.

In some embodiments, the valve is manually operable by a user. In other embodiments, the valve automatically closes the line when fluid enters the line. In some embodiments, the valve automatically closes the line when liquid enters the line. Such embodiments may be advantageous because the automatic operation of the valve may prevent damage to components downstream from the vacuum line, which may occur if liquid passes through the vacuum line. For example, the valve may comprise a float valve.

In some embodiments, one end of the vacuum line joins the fluid flow path downstream of the at least one cyclone and upstream of the suction motor. In further embodiments, the one end of the vacuum line joins the fluid flow path downstream of all air cleaning units and upstream of the suction motor. Such embodiments may be advantageous because increased suction may be provided in the vacuum line. Furthermore, the valve may prevent material from the material collection chamber from entering the suction line, and passing through the motor. It will be appreciated that more than one vacuum line may be used and that each vacuum line may be in flow communication with the inside of the collection bin or the source of vacuum at a plurality of locations.

In some embodiments, the apparatus further comprises a second air cleaning stage, the second air cleaning stage comprising a filter.

In another broad aspect, a surface cleaning apparatus is provided. The surface cleaning apparatus comprises a member having a dirty fluid inlet. A fluid flow path extends from the dirty fluid inlet to a clean air outlet of the surface cleaning apparatus and includes a suction motor. At least a first air cleaning unit comprising a cyclonic cleaning stage is positioned in the fluid flow path. A material collection chamber is provided having an interior in flow communication with the at least one cyclone and adapted to receive a liner bag. A vacuum line is provided having one end joining the fluid flow path downstream of the at least one cyclone and a second end connected to the interior of the material collection chamber.

In some embodiments, the one end of the vacuum line joins the fluid flow path downstream of all air cleaning units and upstream of the suction motor. In further embodiments, the surface cleaning apparatus comprises a second air cleaning stage, and the second air cleaning stage comprises a filter.

In some embodiments, the vacuum line is selectively connectable in flow communication with the fluid flow path. In further embodiments, the surface cleaning apparatus comprises a valve associated with the vacuum line and moveable between a first position in which the vacuum line is open and a second position wherein the line is closed. In some embodiments, the valve is manually operable by a user. In other embodiments, the valve automatically closes the line when fluid enters the line. In some embodiments, the valve automatically closes the line when liquid enters the line. In some embodiments, the valve comprises a float valve.

In some embodiments, the surface cleaning apparatus further comprises a liner bag removably positionable in the material collection chamber.

In another broad aspect, a method is provided for cleaning a surface using a surface cleaning apparatus. The method comprises operating the surface cleaning apparatus by passing a member having a dirty fluid inlet over a surface, conveying a fluid from the dirty fluid inlet to a cyclone separator having a material outlet and conveying material from the cyclone separator past a divider plate to the liner positioned in the material collection chamber, and collecting material inside the liner positioned in the material collection chamber. The method further comprises closing a vacuum line connected to the material collection chamber when a liner is not positioned in the material collection chamber.

In some embodiments, the method further comprises manually closing the vacuum line. In other embodiments, the method further comprises automatically closing the vacuum line in response to fluid flow therethrough.

### BRIEF DESCRIPTION OF THE DRAWINGS

These and other advantages of the present invention will be more fully and particularly understood in connection with the following description of the preferred embodiments of the invention in which:

FIG. 1 is a perspective illustration of an embodiment of a surface cleaning apparatus of the present invention;

FIG. 2 is a perspective illustration of another embodiment of a surface cleaning apparatus of the present invention;

FIG. 3A is a cross-sectional illustration of the embodiment of FIG. 1, taken along line 3-3, showing a configuration of a vacuum line;

FIG. 3B is a close-up view of the material collection chamber shown in FIG. 3A;

FIG. 3C is a cross-sectional illustration of the embodiment of FIG. 1, taken along line 3-3, showing a first alternate configuration of a vacuum line;

FIG. 3D is a cross-sectional illustration of the embodiment of FIG. 1, taken along line 3-3, showing a second alternate configuration of a vacuum line;

FIG. 4 is a cross sectional illustration of the embodiment of FIG. 2, taken along line 4-4;

FIG. 5A is a side view of the embodiment of FIG. 1, showing a cavity of a material collection chamber in an accessible position;

FIG. 5B is a perspective illustration of the embodiment of FIG. 1, showing a cavity of a material collection chamber in an accessible position;

FIG. 6 is a perspective illustration of the embodiment of FIG. 2, showing a cavity of a material collection chamber in an accessible position;

FIG. 7 is an exploded view of the embodiment of FIGS. 5A and 5B with a different surface cleaning head;

FIGS. 8A is a perspective view of an embodiment of a material collection chamber of the present invention in a disassembled configuration, showing a liner bag and a liner bag retaining member;

FIG. 8B is a perspective view of the embodiment of FIG. 8A, in a partially assembled configuration;

FIG. 8C is a perspective view of the embodiment of FIG. 8A, in an assembled configuration;

FIGS. 9A-9B are cross sections taken along line 3-3 in FIG. 1, showing a material collection chamber and the liner bag retainer member of FIGS. 8A-8C removed from a surface cleaning apparatus;

FIG. 10A is a perspective view of an embodiment of a material collection chamber of the present invention in a disassembled configuration, showing a liner bag and an alternate liner bag retaining member;

FIG. 10B is a perspective view of the material collection chamber of FIG. 10A, in an assembled configuration;

FIGS. 11A-11B are cross sections taken along line 3-3 in FIG. 1, showing a material collection chamber and the liner bag retainer member of FIGS. 10A-10B removed from a surface cleaning apparatus;

FIGS. 12A is a close-up view of the vacuum line of FIGS. 3A-3D, showing a valve in an open position;

FIGS. 12B is a close-up view of the vacuum line of FIGS. 3A-3D, showing a valve in a closed position; and

FIG. 13A is a close-up view of the vacuum line of FIGS. 3A-3D, showing an automatically actuated valve in an open position; and,

FIG. 13B is a close-up view of the vacuum line of FIGS. 3A-3D, showing an automatically actuated valve in a closed position;

### DETAILED DESCRIPTION OF THE INVENTION

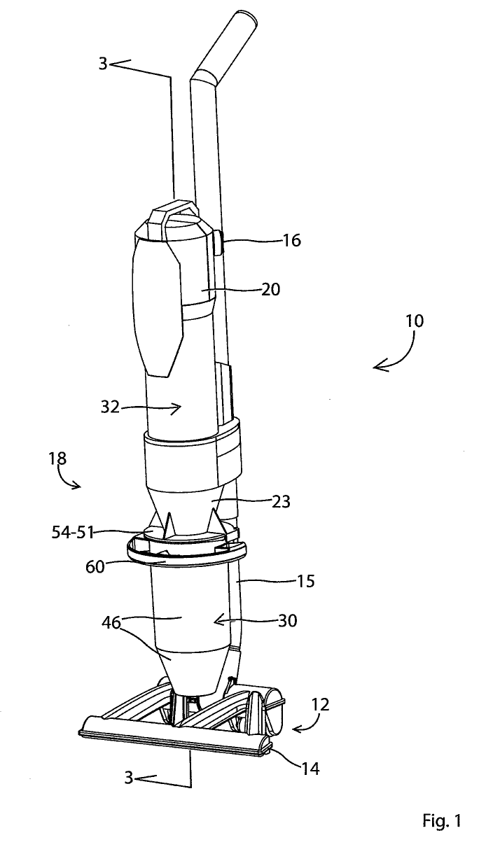

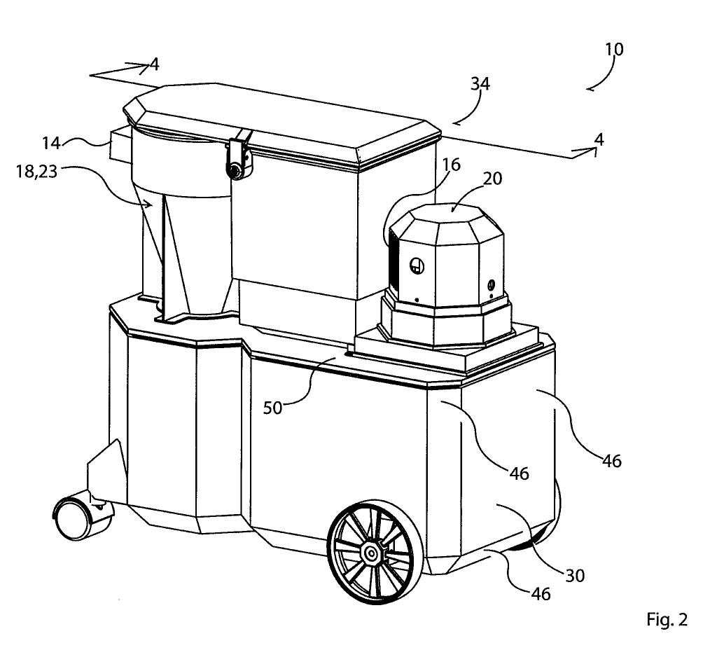

Embodiments of a surface cleaning apparatus 10 of the present invention are shown in FIGS. 1 and 2. In some embodiments, the surface cleaning apparatus 10 may be configured to collect particulate matter. For example, as shown in FIG. 1, the surface cleaning apparatus 10 may be an upright vacuum cleaner. In other embodiments, the surface cleaning apparatus 10 may be another type of surface cleaning apparatus which collects particulate matter, for example a hand vacuum cleaner, a canister type vacuum cleaner, a stick vacuum cleaner, a back pack vacuum cleaner, a carpet extractor or the like. Alternatively, the surface cleaning apparatus 10 may be configured to collect liquids. For example, as shown in FIG. 2, surface cleaning apparatus 10 may be a shop-vac or wet/dry type vacuum cleaner.

The surface cleaning apparatus 10 comprises a member 12 having dirty fluid inlet 14. The fluid passing through the dirty fluid inlet may be air entrained with dirt, or may be air and liquid. In the embodiment of FIG. 1, member 12 is a surface cleaning head. In the embodiment of FIG. 2, as is known in the art, a hose or wand having a distal inlet that may be mounted on a surface cleaning head may be attached to inlet 12. In other embodiments member 12 may be another member having a dirty fluid inlet. A fluid flow path extends from the dirty fluid inlet 14 to a clean air outlet 16. At least a first air cleaning unit 17 comprising a cyclonic cleaning stage 18 is provided in the fluid flow path for removing particulate matter from air, or for removing liquid from air. A fluid flow motor 20 is positioned in the fluid flow path for drawing fluid from the dirty fluid inlet 14 to the clean fluid outlet 16.

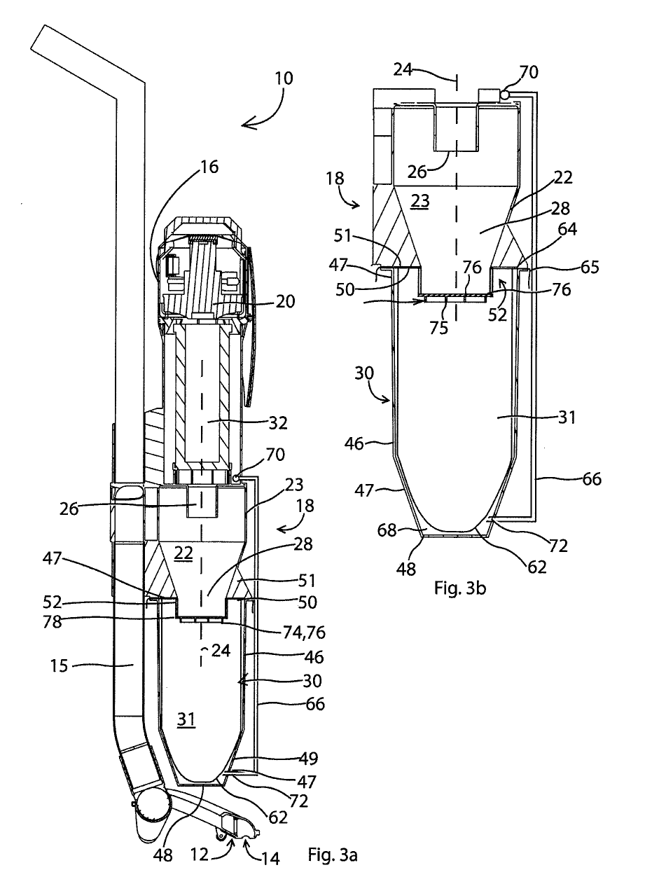

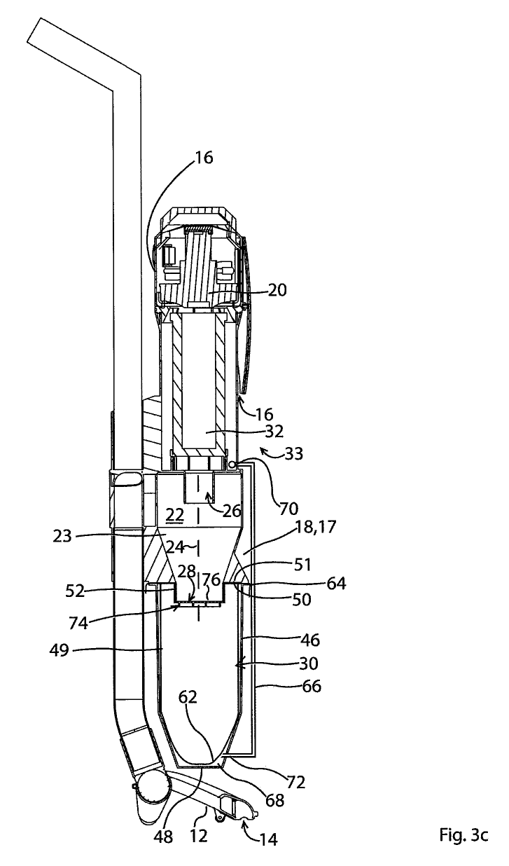

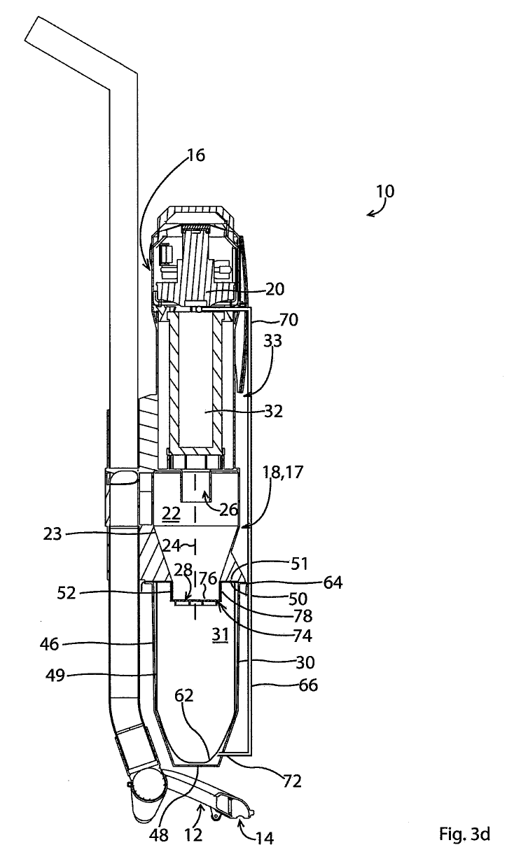

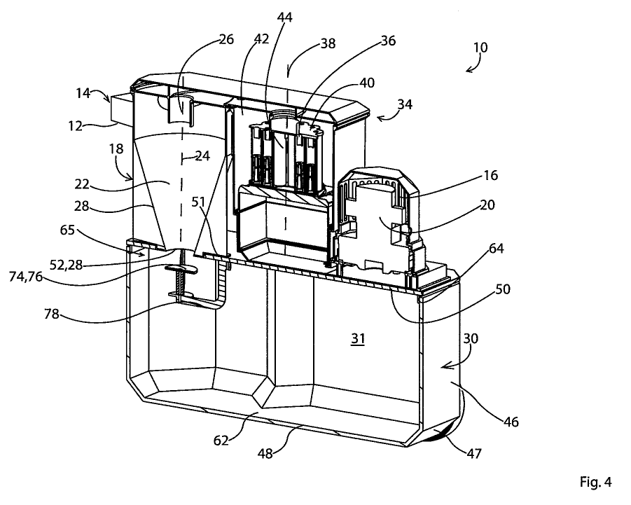

Referring to FIGS. 3A and 4, dirty fluid entering dirty fluid inlet 14 is directed to cyclonic cleaning stage 18. In the embodiment of FIG. 3A, a conduit 15 is provided between dirty fluid inlet 14 and cyclonic cleaning stage 18. In the embodiments shown, cyclonic cleaning stage 18 comprises a single cyclone chamber 22 defined in a cyclone 23, which extends longitudinally along a first longitudinal axis 24. In other embodiments, cyclonic cleaning stage 18 may comprise a plurality of cyclones. Cyclone 23 comprises a clean air outlet 26, and a material outlet 28. A material collection chamber 30, as will be described further hereinbelow, is positioned below dirt outlet 28.

In some embodiments, air exiting cyclone chamber 22 may be directed past motor 20, and out of clean fluid outlet 16. Alternatively, air exiting cyclone chamber 22 may be directed to one or more additional air cleaning units 33, such as another component, for example housing a filter 32, prior to flowing past motor 20, and out of clean fluid outlet 16, as shown in FIG. 3A. In another embodiment, as shown in FIG. 4, air exiting cyclone chamber 22 through clean air outlet 26 is directed to a second cleaning stage 34, past motor 20, and out of clean fluid outlet 16. In the embodiment shown, the second cleaning stage 34 comprises a plurality of second cyclones 36 in parallel.

The second cleaning stage 34 has, in the example exemplified, a generally cylindrical configuration with a second longitudinal axis 38. The second axis 38 is parallel to, and laterally offset from, first axis 24. Each of the second cyclones 36 in the assembly receives air from the clean air outlet 26 of the first cyclone, and discharges air through outlets 40 into a manifold 42. Air is evacuated from the manifold 42 through a conduit 44 disposed centrally of the assembly. From the conduit 44 the air is drawn towards the motor 20, and expelled from the apparatus 10 through clean air outlet 16. In addition, in some embodiments the additional cleaning stage 34 may include a filter element, such as a pre-motor foam membrane, disposed in the fluid stream between the cleaning stage 34 and the motor 20.

As previously mentioned, a material collection chamber 30 (referred to hereinafter as chamber 30) is positioned below cyclone 23. Chamber 30 collects material discharged from dirt outlet 28 of cyclone 23. The discharged material may comprise fluid and/or particulate matter for example. Chamber 30 comprises at least one wall defining a cavity 31 and may be of any configuration.

For example, in the embodiment of FIGS. 3A and 3B, chamber 30 comprises a cylindrical upper sidewall 46, a frustoconical lower side wall 47, a bottom wall 48, and a top wall 50. Top wall 50 is provided by a lower surface 51 that may be a flange surrounding cyclone 22, which abuts the upper end 47 of upper sidewall 46.

Alternately, in the embodiment of FIG. 4, chamber 30 comprises a plurality of upper side walls 46 which meet at an angle, a plurality of optional lower side walls 47 which meet at an angle, a bottom wall 48, and a top wall 50. Chamber 30 further comprises at least one material inlet 52 in fluid communication with material outlet 28. In the embodiments shown, material inlet 52 is defined in top wall 50. In some embodiments, material outlet 28 and material inlet 52 may coincide. In other embodiments, material outlet 28 and material inlet 52 may be separate, and a conduit may be provided for providing fluid communication therebetween

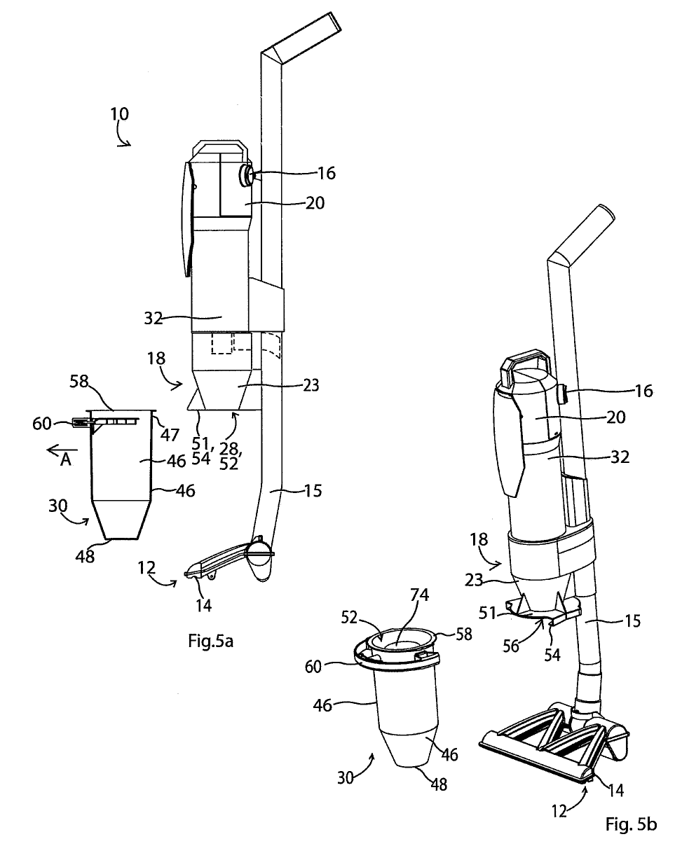

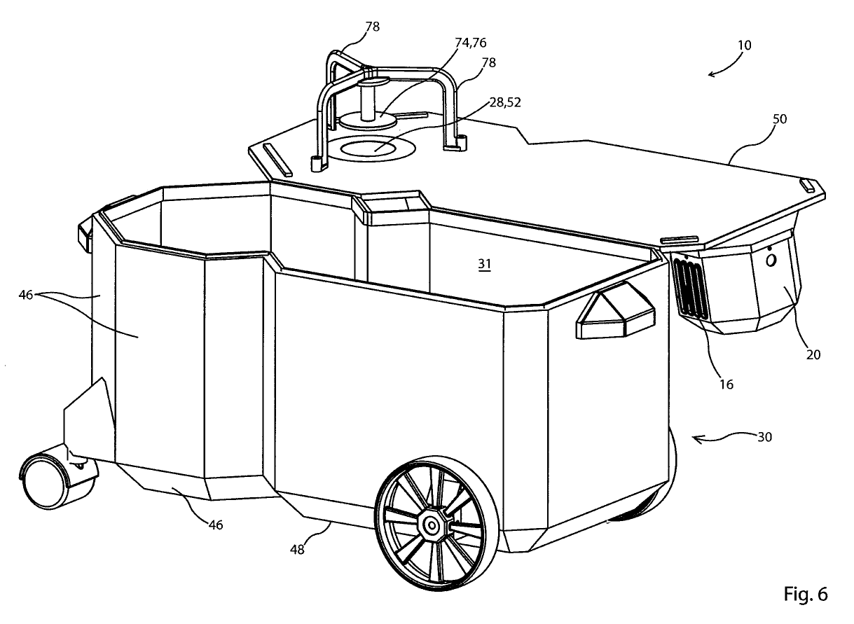

Chamber 30 is adapted to receive a liner bag. Cavity 31 of chamber 30 is accessible, such that the liner bag may be emptied. For example, in the embodiment shown in FIGS. 5A and 5B, chamber 30 is movable relative to cyclone 22, and removable therefrom, such that cavity 31 may be accessed. That is, flange 51 is provided with C-channels 54, which define a slot 56 for slidably receiving a rim 58 provided on side walls 46. Additionally, chamber 30 is provided with a handle 60. Accordingly, in order to remove chamber 30, a user may grasp handle 60 and slide chamber 30 away from cyclone chamber 22 in the direction of arrow A. In the embodiment of FIG. 6, chamber 30 is openable, such that cavity 31 may be accessed. That is top wall 50 of chamber 30 may be pivoted away from chamber 30 such that chamber 30 may be opened. In other embodiments, cavity 31 may be accessible in another manner. For example, a door may be provided for removing the liner, chamber 30 may be pivotally mounted to the cyclone or another portion of the surface cleaning apparatus. In any such embodiments, chamber 30 may optionally be provided with a gasket or other sealing member for sealing chamber 30 to cyclone chamber 23 when cavity 31 is not in an accessible position.

In some embodiments, surface cleaning apparatus 10 also includes a divider plate 74 associated with, and preferably positioned adjacent the material outlet 28 of the cyclone chamber 23. Divider plate may be any plate known in the art that is positionable between a cyclone outlet and a dirt collection chamber.

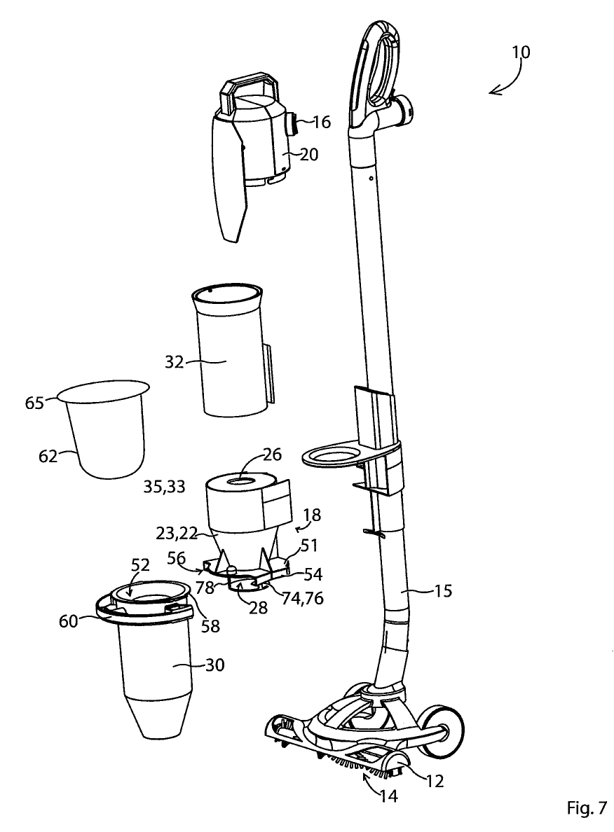

In the example illustrated in FIGS. 3A and 3B, the divider plate 74 is positioned within the chamber 30, adjacent to but spaced below the material outlet 28. The divider plate 74 may generally comprises a disc 76 having reinforcing ribs 75 therebelow that, when positioned below the dirt outlet 28, has a diameter slightly greater than the diameter of the dirt outlet 28, and disposed in facing relation to the dirt outlet 28. The disc 76 is, in the examples illustrated, mounted to apparatus 10 by one or more supports 78. In the embodiment of FIGS. 3A and 7, supports 78 are mounted to flange 51 surrounding cyclone chamber, and extend downwardly into chamber 30 to support disc 76. In the embodiment of FIG. 4 supports 78 are mounted to top wall 50 of chamber 30, and extend downwardly into chamber 30 to support disc 76. Alternately, support(s) 78 may be mounted to a sidewall 46 of chamber 30. In other embodiments, divider plate 74 may be positioned within material outlet 28. In such an embodiment, dirt chamber inlet 52 may be defined between top wall 50 and divider plate 74, and may be substantially annular.

As previously mentioned, surface cleaning apparatus 10 is adapted to receive a liner, such as liner bag 62, for lining chamber 30. Liner bag 62 may be essentially a plastic bag, cloth bag or the like that is disposable and is preferably impermeable to air flow therethrough. Referring to FIGS. 3B and 4, liner bag 62 may extend along the inner surface 49 of chamber 30 at side walls 46 and bottom wall 48, and may be dimensioned to sit against inner walls 49 of chamber 30 (e.g., it is of the same size and shape). Liner bag 30 may aid a user in emptying chamber 30, as will be described further hereinbelow. It will be appreciated that liner bag need not be configured to rest against all of the sidewalls and bottom wall of chamber 30, which is preferred, but may be of a different shape.

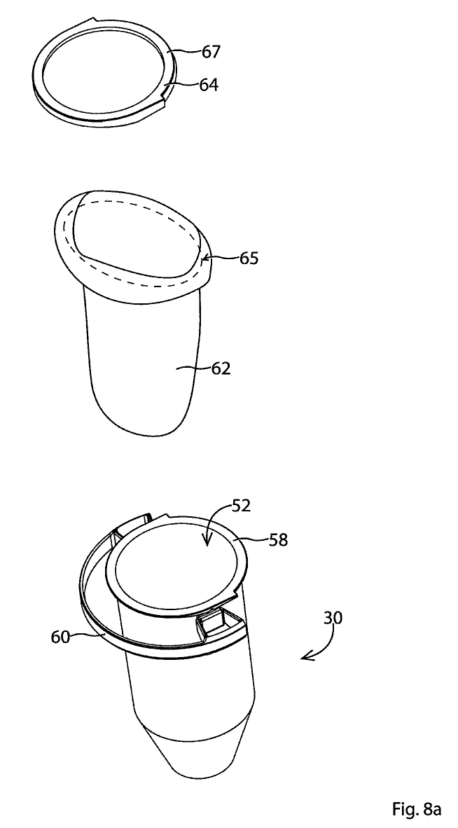

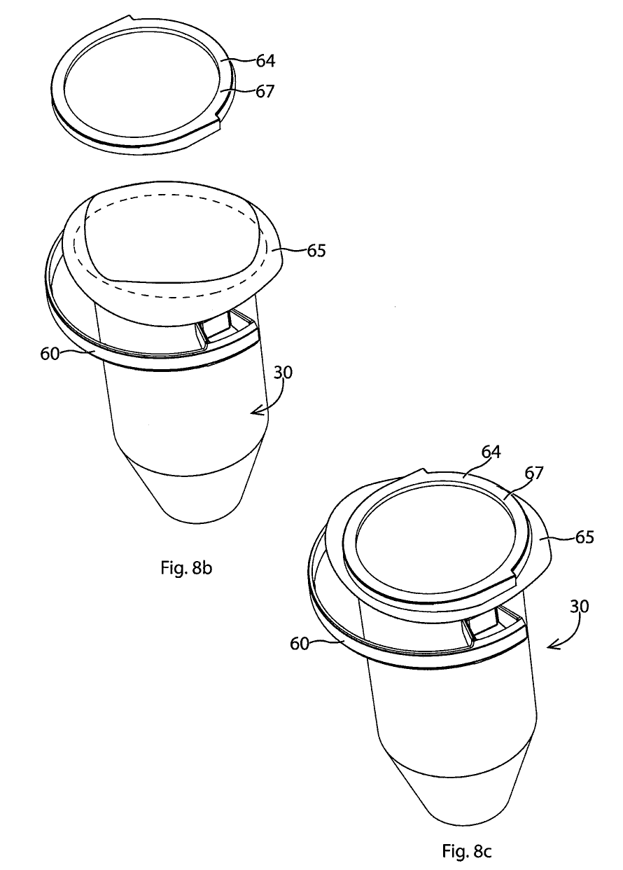

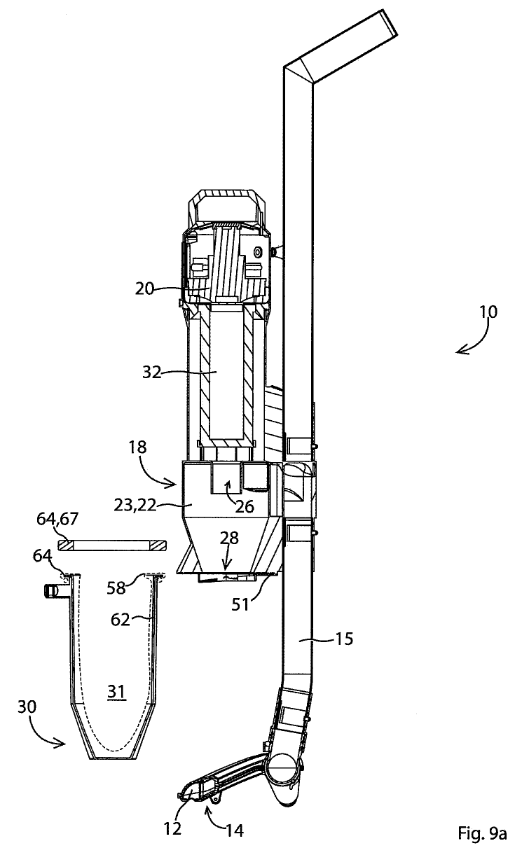

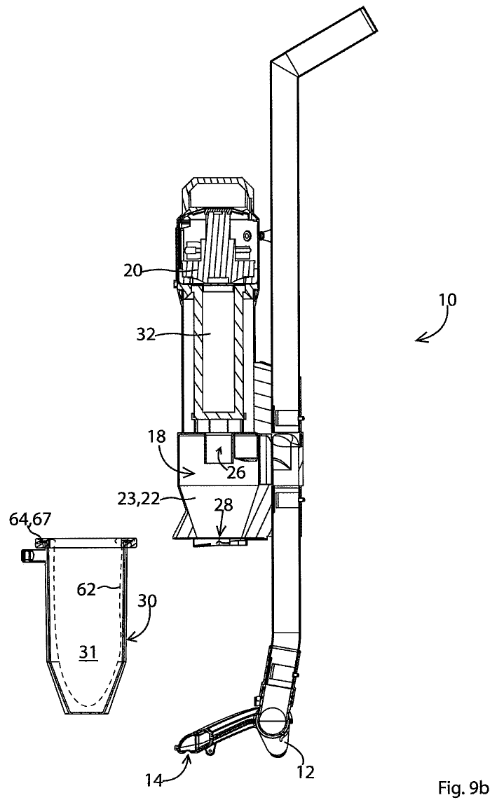

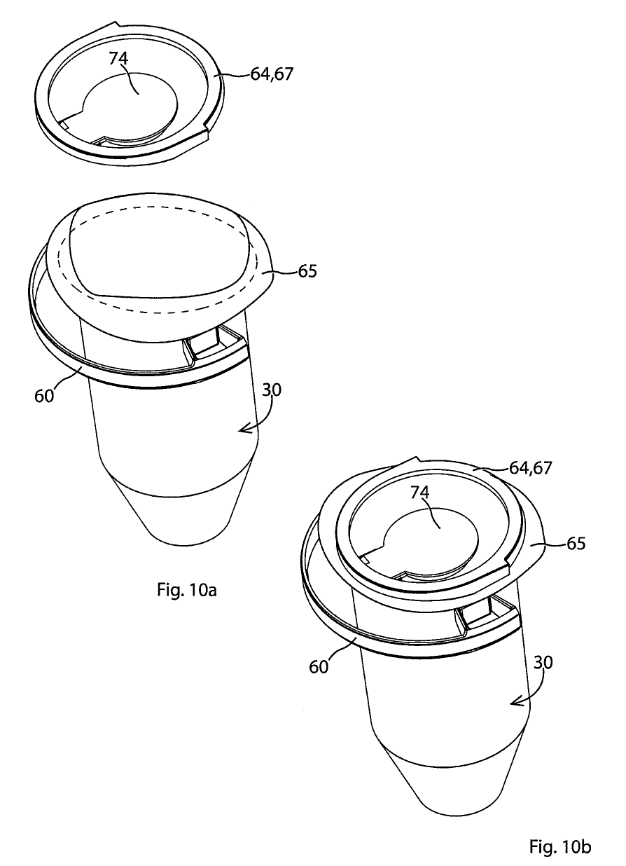

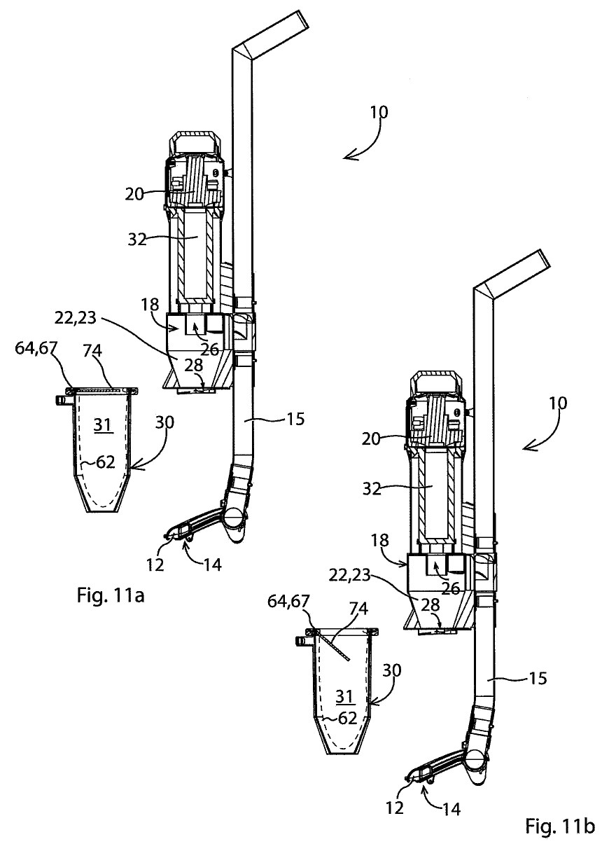

In some embodiments, surface cleaning apparatus 10 may further comprise a liner bag retaining member 64, for holding a portion of liner bag 62 in place within chamber 30. In the embodiment of FIG. 3B, liner bag retaining member 64 comprises rim 60 and C-channel 56 (see FIG. 5B), between which an upper portion 65 of liner bag 62 is pinched, and secured in place. In the embodiment of FIG. 4, liner bag retaining member 64 comprises an upper portion of sidewalls 46, and a perimeter of top wall 50, between which an upper portion 65 of liner bag 62 is pinched and secured in place. In the embodiment shown in FIGS. 8A-8C, and 10A-10B, liner bag retaining member comprises a collar 67, which is placed on rim 60 on top of upper portion 65 of liner bag 62, to secure upper portion 65 in place. Collar 67 and/or rim 60 may then be slid into C-channel 56 together with material collection chamber 30. Collar 67 may be secured thereto such as by a snap fit, a magnet, a releasable adhesive, mechanical securing members such as a latch, clips, a set screw or the like. In some embodiments, as shown in FIGS. 10A-10B, divider plate 74 may be mounted to collar 67. In such an embodiment, divider plate 74 may be movable with respect to collar 67, such that a user may empty material collection chamber 30, without removing collar 67 or liner bag 62, as shown in FIG. 11B. In other embodiments, liner bag retaining member 64 may comprise other members. For example, chamber 30 may be provided with one or more of clips, hooks, or an adhesive on inner wall 49 and/or on an outer surface of liner bag 62 for securing liner bag 62 in place.

In some embodiments, the suction provided by motor 20 may be used to aid in maintaining liner bag 62 in place. For example, referring to FIG. 3B-3D, the pressure at the upper portion of cyclone chamber 22 (i.e. adjacent the cyclone inlet) and at portions of the fluid flow path downstream therefrom will be lower than the pressure in chamber 30. Accordingly, in order to assist in maintaining liner bag 62 adjacent inner surface 49 of chamber 30, one or more vacuum lines 66 may be provided. In the embodiment shown in FIG. 3B, vacuum line 66 extends from cyclone chamber 22 to interstitial cavity 68, which is defined as the space between liner bag 62 and the inner wall 49 of chamber 30. In this embodiment, the outlet 70 of vacuum line 66 is positioned proximate the inlet (or as part of the inlet) of cyclone chamber 22. In other embodiments, the vacuum line may extend from a point downstream of cyclone chamber 22, and upstream of motor 20, to interstitial cavity 68. For example, in the embodiment of FIG. 3C, the vacuum line extends from the second air cleaning unit, comprising filter 32, to interstitial cavity 68. In yet other embodiments, the vacuum line may extend from a point downstream from all air cleaning units, and upstream of motor 20, as shown in FIG. 3D. Preferably, the inlet end 72 of vacuum line 66 is provided in a plurality of positions, preferably adjacent bottom wall 48 of chamber 30. The flow of air from inlet end 72 to outlet end 70 will assist in securing liner bag 62 in position. It will be appreciated that a liner bag may be used with any of the aspects of the vacuum.

In some embodiments, the vacuum line 66 may be selectively connectable in flow communication with the fluid flow path. For example, a valve 82 may be associated with the vacuum line, and may be movable between a first position, in which the vacuum line is open, and a second position, wherein the line is closed, or partially closed. Valve 82 may be useful in situations wherein a user elects not to use a liner bag. In such situations, the user may use valve 82 to close the vacuum line, such that material entering material collection chamber 30 may not enter the vacuum line.

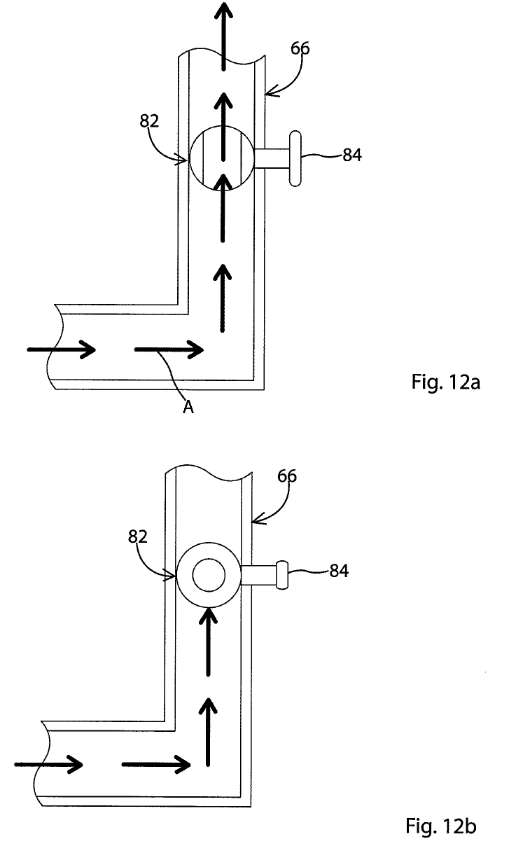

In some embodiments, valve 82 may be manually operable by a user. For example, referring to FIGS. 12A and 12B, wherein the direction of airflow is indicated by arrows A, valve 82 may be a stopcock type valve, and may comprise a control 84 which may be actuated by a user from an open position, shown in FIG. 12A, to a closed position, shown in FIG. 12B. Alternately, valve 82 may be a moveable plate provided to overlie the opening or openings of line 66 in the collection chamber.

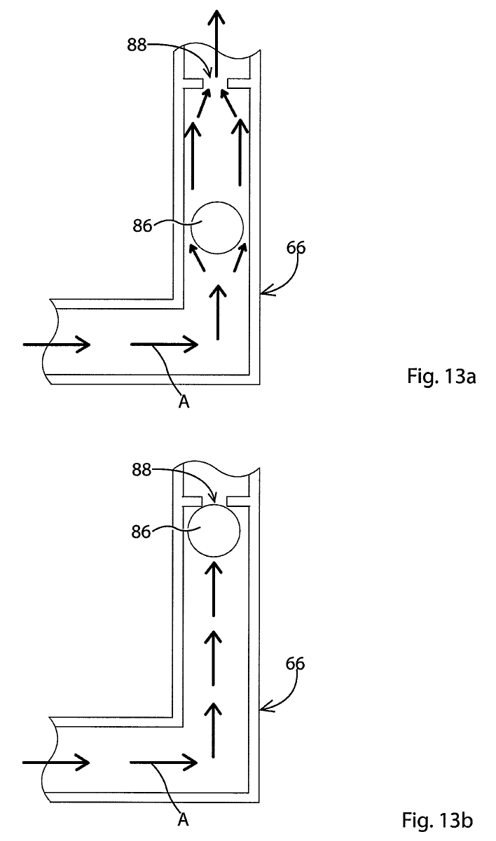

In other embodiments, valve 82 may be automatically operated. For example, referring to FIGS. 13A and 13B, valve 82 may automatically close when liquid or fluid enters vacuum line 66. In such embodiments, valve 82 may comprise a float ball 86, which, when fluid enters vacuum line 66, is pushed upwards into inlet 88, such that inlet 88 is occluded and liquid or fluid may not pass therethrough. For example, float ball 86 may be selected such that it will not close inlet 88 when air is flowing therethrough but will close it if water is provided therein. Alternately float ball 86 may be selected such that it will only close inlet 88 if there is continuous airflow therethrough (e.g., a liner is not in place) but will not close inlet 88 if there is a lower air flow therethrough, or no air flow (e.g. a liner is in place).

In use, a user may elect to operate surface cleaning apparatus 10 with a liner bag 62 in material collection chamber 30, or without a liner bag 62 in material collection chamber 30.

If the user elects to operate apparatus 10 with a liner bag 62, the user may access cavity 31 of chamber 30 by opening chamber 30, or by removing chamber 30 from apparatus 10. The user may then place liner bag 62 in chamber 30, and return chamber 30 to an operational position. The user may then ensure that vacuum line 66 is open, for example by actuating a valve 82 if valve is manually operable. For example, the valve may be operated by a knob, lever or the like on the outer housing of the surface cleaning apparatus and moveable between two positions labeled “bag” and “no bag”. It will be appreciated that valve 82 may be driven by an electric motor and an electronic control may be used to open and close the valve. The surface cleaning apparatus may also have a dectector (e.g., an electrical contact that is blocked when a bag is properly positioned) to determine when a bag is in place and to open the valve when a bag is in place and to close valve 82 when no bag is detected.

If the user elects to operate apparatus 10 without a liner bag 62, the user may close the vacuum line 66, either prior to operating the surface cleaning apparatus, or during operation of the surface cleaning apparatus, if valve 82 is manually operated. The vacuum line 66 may be closed manually, or may be closed automatically, in response to fluid flow therethrough.

The user may operate apparatus 10 by engaging motor 20 and passing member 12 over a surface. As member 12 is passed over the surface, fluid will be conveyed from dirty fluid inlet 14 into cyclone 23, past a divider plate 74, and into chamber 30, which may or may not contain a liner bag 62. As the apparatus is operated, material will collect in chamber 30. When the operation of the apparatus 10 is discontinued, the user may again access cavity 31 of chamber 30, and empty cavity 31. If chamber 30 contains a liner 62, the user may remove liner 62 from chamber 30, (instead of carrying chamber 30 to a receptacle or after carrying chamber 30 to the receptacle). The user may then optionally gather the upper portion 65 of liner bag 62, and seal liner bag 62, for example by tying a knot in upper portion 65. The user may then dispose of liner bag 62, and optionally place a new liner bag in chamber 30.

It will be appreciated that certain features of the invention, which are, for clarity, described in the context of separate embodiments or separate aspects, may also be provided in combination in a single embodiment. Conversely, various features of the invention, which are, for brevity, described in the context of a single embodiment or aspect, may also be provided separately or in any suitable sub-combination. For example, the vacuum line and valve may be used with any collection chamber for a surface cleaning apparatus that may use a liner.

Although the invention has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present invention.

I claim:

1. A surface cleaning apparatus comprising:
(a) a member having a dirty fluid inlet;
(b) a fluid flow path extending from the dirty fluid inlet to a clean air outlet of the surface cleaning apparatus and including a suction motor;
(c) at least a first air cleaning unit comprising a cyclonic cleaning stage positioned in the fluid flow path;
(d) a material collection chamber in flow communication with the at least one cyclone and adapted to receive a liner bag;
(e) a vacuum line extending between the fluid flow path and an interior of the material collection chamber and connectable in flow communication with the fluid flow path; and,
(f) a valve associated with the vacuum line and moveable between a first position in which the vacuum line is open and a second position wherein the line is closed.

2. The surface cleaning apparatus of claim 1 wherein the valve is manually operable by a user.

3. The surface cleaning apparatus of claim 1 wherein the valve automatically closes the line when fluid enters the line.

4. The surface cleaning apparatus of claim 1 wherein the valve automatically closes the line when liquid enters the line.

5. The surface cleaning apparatus of claim 4 wherein the valve comprises a float valve.

6. The surface cleaning apparatus of claim 1 wherein one end of the vacuum line joins the fluid flow path downstream of the at least one cyclone and upstream of the suction motor.

7. The surface cleaning apparatus of claim 6 wherein the one end of the vacuum line joins the fluid flow path downstream of all air cleaning units and upstream of the suction motor.

8. The surface cleaning apparatus of claim 7 further comprising a second air cleaning stage, the second air cleaning stage comprising a filter.

9. A surface cleaning apparatus comprising:
(a) a member having a dirty fluid inlet;
(b) a fluid flow path extending from the dirty fluid inlet to a clean air outlet of the surface cleaning apparatus and including a suction motor;
(c) at least a first air cleaning unit comprising a cyclonic cleaning stage positioned in the fluid flow path;
(d) a material collection chamber having an interior in flow communication with the at least one cyclone and adapted to receive a liner bag; and,
(e) a vacuum line having one end joining the fluid flow path downstream of the at least one cyclone and a second end connected to the interior of the material collection chamber.

10. The surface cleaning apparatus of claim 9 wherein the one end of the vacuum line joins the fluid flow path downstream of all air cleaning units and upstream of the suction motor.

11. The surface cleaning apparatus of claim 10 further comprising a second air cleaning stage, the second air cleaning stage comprising a filter.

12. The surface cleaning apparatus of claim 9 wherein the vacuum line is selectively connectable in flow communication with the fluid flow path.

13. The surface cleaning apparatus of claim 12 further comprising a valve associated with the vacuum line and moveable between a first position in which the vacuum line is open and a second position wherein the line is closed.

14. The surface cleaning apparatus of claim 13 wherein the valve is manually operable by a user.

15. The surface cleaning apparatus of claim 13 wherein the valve automatically closes the line when fluid enters the line.

16. The surface cleaning apparatus of claim 13 wherein the valve automatically closes the line when liquid enters the line.

17. The surface cleaning apparatus of claim 16 wherein the valve comprises a float valve.

18. The surface cleaning apparatus of claim 9 further comprising a liner bag removably positionable in the material collection chamber.

19. A method for cleaning a surface using a surface cleaning apparatus comprising:
(a) operating the surface cleaning apparatus comprising:
i. passing a member having a dirty fluid inlet over a surface;
ii. conveying a fluid from the dirty fluid inlet to a cyclone separator having a material outlet and conveying material from the cyclone separator past a divider plate to the liner positioned in the material collection chamber;
iii. collecting material inside the liner positioned in the material collection chamber; and,
(b) closing a vacuum line connected to the material collection chamber when a liner is not positioned in the material collection chamber.

20. The method of claim 19 further comprising manually closing the vacuum line.

21. The method of claim 19 further comprising automatically closing the vacuum line in response to fluid flow therethrough.
